(19) United States
(12) Patent Application Publication
(10) Pub. No.: US 2003/0123492 A1
(43) Pub. Date: Jul. 3, 2003

(54) Efficient multiplexing system and method

(76) Inventor: Samuel Ray Locke, Richardson, TX (US)

Correspondence Address: GRAY, CARY, WARE & FREIDENRICH LLP, 1221 SOUTH MOPAC EXPRESSWAY, SUITE 400, AUSTIN, TX, 78746-6875, US

(21) Appl. No.: 09/854,797

(22) Filed: May 14, 2001

(51) Int. Cl. H04J 3/02

(52) U.S. Cl. 370/537; 370/389

(57) ABSTRACT

An efficient multiplexing method is disclosed. The method includes receiving a message at a first of a plurality of ports. The message is associated with a destination. The method also includes, if the destination is the first of the plurality of ports, sending the message to the destination; else if the destination is a designated distributor, the method includes associating with the message a destination identifier of the first of the plurality of ports and sending the message to the designated distributor through a switching fabric. The method also includes, else if the destination is not the designated distributor, sending the message to the destination through the switching fabric. In a particular embodiment, the plurality of ports is the sum of one and n and the switching fabric uses n-to-one multiplexing logic, wherein n is a multiple of two.

### TECHNICAL FIELD OF THE INVENTION

This invention relates in general to the field of data communications. In particular, the invention relates to a method and system for an efficient multiplexing system and method.

### BACKGROUND OF THE INVENTION

Communications network technology is developing at a rapid pace and increasing in complexity. Such developments include increases in network bandwidth and processor and bus speeds, and have been accompanied by demand for increased throughput and computational power. In some applications, fabrics such as switch fabrics, control fabrics, and datapath fabrics have been developed to increase switching speed and/or throughput. In many applications, crossbar designs have been used, to ensure that no processor is more than a single ‘hop’ away from another. Crossbar designs generally allow multiple processors to communicate with each other simultaneously. Unfortunately, crossbar designs may suffer from any latency in the fabric or switch, and as networks grow, so too does the complexity and amount of logic needed to multiplex a given number of signal inputs.

In many applications, it may also be desirable to broadcast a message; that is, to simultaneously or virtually simultaneously send a single message to two or more network nodes or ports. For example, applications such as real-time audio and video conferencing, LAN TV, desktop conferencing, corporate broadcasts, and collaborative computing require simultaneous or virtually simultaneous communication between networks or groups of computers. These applications are very bandwidth-intensive, and require extremely low latency from an underlying network multicast service. Broadcast messaging, where a message is sent to all known nodes or ports, includes multicast messaging, where a message is sent to a specified list of those nodes or ports.

Broadcast messaging has been successfully deployed in memory-based switch systems in some networks. Unfortunately, the available bandwidth for such messaging decreases with speed. Thus, broadcast messaging breaks down at higher speeds such as in multi-gigabit networks. Such messaging is also not scalable.

### SUMMARY OF THE INVENTION

From the foregoing, it may be appreciated that a need has arisen for a system and method for an efficient multiplexing system and method. In accordance with teachings of the present invention, a system and method are provided that may substantially reduce or eliminate disadvantages and problems of conventional communications systems.

For example, a switching method is disclosed. The method includes receiving a message at a first of a plurality of ports. The message is associated with a destination. The method also includes, if the destination is the first of the plurality of ports, sending the message to the destination; else if the destination is a designated distributor, the method includes associating with the message a destination identifier of the first of the plurality of ports and sending the message to the designated distributor through a switching fabric. The method also includes, else if the destination is not the designated distributor, sending the message to the destination through the switching fabric. In a particular embodiment, the plurality of ports is the sum of one and n and the switching fabric uses n-to-one multiplexing logic, wherein n is a multiple of two.

The invention provides several important advantages. Various embodiments of the invention may have none, some, or all of these advantages. For example, the invention may provide the technical advantage of allowing multicast and broadcast of messages over a variety of architectures with selectable outputs such as fabric and crossbar architectures. Another technical advantage of the invention is that the invention may reduce latency in the fabric or switch. Another technical advantage of the invention is that the invention may provide multicast and/or broadcast of messages at full line rates for a variety of networks.

The invention may also provide the technical advantage of reducing the logic required to multiplex a given number of signal inputs. In cases where the number of inputs is large, such a reduction may be significant. Such an advantage may reduce latency in the switch and increase switch performance by removing the requirement for an additional layer of multiplexing. Other technical advantages may be readily ascertainable by those skilled in the art from the following figures, description and claims.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a block diagram of a switching network in accordance with teachings of the invention;

FIG. 2 illustrates a method for providing efficient multiplexing in accordance with teachings of the present invention; and

FIG. 3 illustrates an example of forwarding data that may be used according to teachings of the present invention.

### DETAILED DESCRIPTION OF THE DRAWINGS

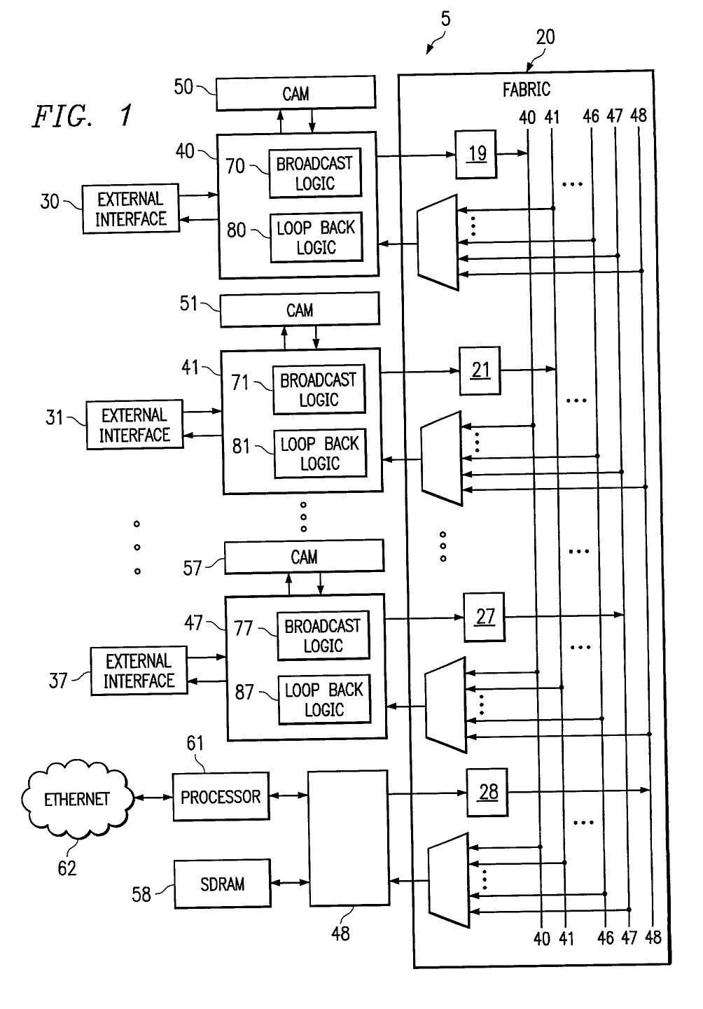

FIG. 1 is a block diagram of a switching network utilizing teachings of the invention. Network 5 includes a plurality of nodes or port interfaces (PIFs) 40-48 that are each coupled to a switch fabric 20 and respectively coupled to a memory 50-58. In a particular embodiment, port interface 48 may be a designated port interface or designated distributor that may be referred to as a computer interface (CIF) 48 for clarity. Network 5 is operable to receive messages from a variety of sources at each of PIFs 40-47 and CIF 48, and communicate the messages at high speed to one or more designated destinations with reduced switch latency. For example, when a message is received at a first of the plurality of nodes, forwarding data associated with the received message may be retrieved from memory, and the message and at least a portion of the forwarding data may be sent through fabric 20 to designated distributor 48 in response to the forwarding data if it is to be broadcast to at least two nodes in the network. The message may then be sent from designated distributor 48 through the fabric to a plurality of destinations in the network using the forwarding data.

In this example, in a particular embodiment, if the destination of the message is the first of the plurality of nodes, the message may be looped back to the destination without being sent through the fabric. On the other hand, if the message is to be broadcast, the message may be associated with a destination identifier of the first of the plurality of nodes before it is sent to the designated distributor through fabric 20. Thus, where a message's own port identifier equals the destination address, the message is sent to a designated distributor or broadcast port interface such as CIF 48. Such an advantage provides increased efficiency by reducing the logic that would otherwise be needed. For example, in many applications such an embodiment may remove an extra logic level and/or an additional layer of multiplexing that might otherwise be required to accommodate an additional switch beyond an even power of two. Such an advantage may also reduce the latency and improve the performance of the switch fabric 20.

The messages may be broadcast at full line rates using a variety of networks that include architectures with selectable or multiplexed outputs such as crossbar switch fabric architectures, at network elements such as, but not limited to, switches, routers, and hubs. These messages may be any type of data, including voice, video, and other digital or digitized data, and may be structured as micro-packets or cells. In some applications, these cells may include 32 bytes.

PIFs 40-47 are each respectively coupled to an external interface 30-37 to receive and send messages, and CIF 48 may be coupled to a processor 61, which may be coupled to an external network 62. External interfaces 30-37 and/or network 62 may be a computer or part of a network such as a local area network (LAN) or wide area network (WAN). In a particular embodiment, external interfaces 30-37 may be a Media Access Control (MAC) element that provides low-level filtering for reliable data transfer to other computers or networks. As one example, such other networks may be portions of one or more Gigabyte System Networks (GSNs), which are physical-level, point-to-point, full-duplex, link interfaces for reliable, flow-controlled, transmission of user data at rates of approximately 6400 Mbit/s, per direction.

Message traffic through network 5 may be described using the terms “inbound” and “outbound”. For example, transfers from external interfaces 30-37 and processor 61 to fabric 20 or CIF 48 may be defined as inbound message traffic, while outbound traffic may refer to message data traveling the reverse direction. For example, messages traveling from CIF 48 to one or more PIFs 40-47 may be defined as outbound.

Each PIF 40-47 includes broadcast logic 70-77 to process inbound messages. In a particular embodiment, PIFs 40-47 may also include loopback logic 80-87. Although this logic may be arranged in a variety of logical and/or functional configurations, it may be desirable to include one or more inbound modules for broadcast and/or loopback logic for each PIF 40-47, one or more outbound modules to process outgoing messages for each PIF 40-47, and/or a variety of queues (none of which are explicitly shown). Such a configuration may be desirable in, for example, high-speed or rate-matching applications.

In a particular embodiment, CIF 48 may include first-in, first-out (FIFO) buffers for both inbound and outbound traffic, message formatting logic, and controllers to facilitate traffic flow to/from fabric 20. Alternatively or in addition, CIF 48 may also include input/output pads, FIFO buffers for both inbound and outbound traffic, and read and write address FIFO buffers and controllers to facilitate traffic flow to/from memory 58 and/or to/from processor 61.

Memory elements 50-58 may be implemented using a variety of methods. For example, memory elements 50-58 may be flat files, hierarchically organized data such as database managed data, Random Access Memory (RAM), Dynamic Random Access Memory (DRAM) and Content Addressable Memory (CAM). In a particular embodiment, memory 50-57 may be a CAM. Alternatively or in addition, memory element 58 may be a broadcast Synchronous DRAM (SDRAM). In some embodiments, it may be advantageous to utilize a memory element 58 that achieves a desired throughput rate. For example, a memory element 58 may be a sixteen megabyte SDRAM. For example, two 100 megahertz 128-bit Dual Inline Memory chips (DIMs) may support 1600 megabyte-per-second access throughput, or 800 megabytes for inbound and 800 megabytes for outbound message traffic.

In a particular embodiment, fabric 20 may be a non-blocking crossbar switch fabric, where traffic between two nodes does not interfere with traffic between two other nodes. For example, fabric 20 provides a crossbar capability where each output PIF 40-48 may be selected by any one of four virtual channels from any other input PIF 40-48. That is, a given PIF output may not be selected from its own input, or vice-versa, through fabric 20. In a particular embodiment, fabric 20 may include one or more Field-Programmable Gate Arrays (FPGAs). Fabric 20 may also support local buffer staging for gapless switching between destinations and provide arbitration and fairness functions. For example, fabric 20 may include buffers 19 and 21-28 that may be used to store one or more packets sent from PIFs 40-48 respectively.

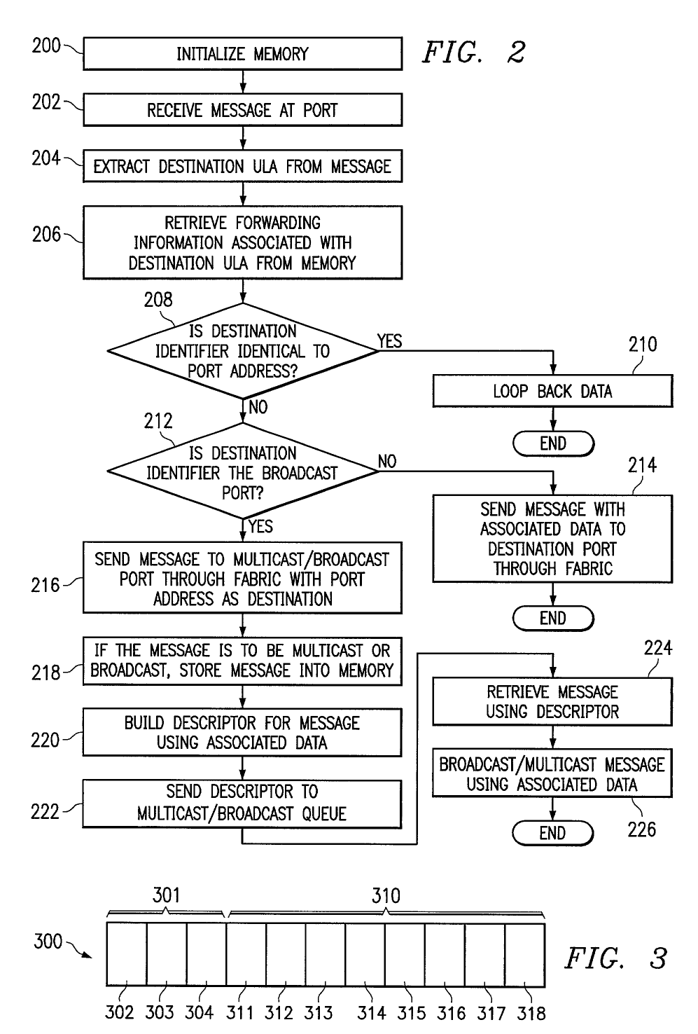

FIG. 2 illustrates a method for providing efficient multiplexing utilizing aspects of the present invention. Although steps 200-226 are illustrated as separate steps, various steps may be ordered in other logical or functional configurations, or may be single steps.

In step 200, one or more memory elements 50-58 may be initialized. Memory initialization may include, for example, storing the logical hardware address of a source and/or a destination PIF or interface that may be mapped to, or associated with, a PIF identifier. One example of such a logical hardware address may be a Universal LAN MAC Address (ULA), a 48-bit globally unique address administered by the IEEE. The ULA may be assigned to each PIF 40-48 on an Ethernet, FDDI, 802 network, or HIPPI-SC LAN. For example, HIPPI-6400 uses Universal LAN MAC Addresses that may be assigned or mapped to any given PIF 40-48 using many methods. One such method is specified in IEEE Standard 802.1A or a subset as defined in HIPPI-6400-SC.

Steps 202-226 are described below using a message received at PIF 40 that includes a destination for the message that is mapped to a destination ULA for illustrative purposes. In step 202, PIF 40 receives a message from external interface 30. In step 204, a destination ULA is extracted from the message. Such extraction may be performed using a variety of methods, including obtaining forwarding information for the message at an address located in a CAM 50.

In step 206, the forwarding information associated with the destination ULA is retrieved from memory 50. In a particular embodiment, forwarding information may include a destination identifier and associated data, which identifies designated locations to which the message is to be broadcast. One example of associated data that may be used is a broadcast map that is described in further detail in conjunction with FIG. 3.

In step 208, if the message is to be sent to a destination that corresponds to the PIF that received the message, in this case PIF 40, the inbound message may be “looped back”, or be sent outbound directly from PIF 40 in step 210, before traversing fabric 20. The method then ends. As one example, PIF 40 may include loopback logic 80 to facilitate this method, which may reduce switch latency and the complexity of logic required, because the message does not have to be sent through fabric 20.

On the other hand, the message may be broadcast or sent to another PIF. The method may utilize a destination identifier to designate a particular destination for the message. Thus, if the message is to be broadcast to at least two elements in the network, the destination identifier may indicate the message is to be sent to a designated distributor or broadcast port, in this example CIF 48. In step 212, the method queries whether the destination identifier indicates the designated distributor. If not, then the message is sent with the associated data to the destination identifier in step 214 through fabric 20. For example, if a message is to be sent to a destination identifier that corresponds to a particular PIF 40-47, that message is sent through fabric 20 to that PIF. The method then ends.

On the other hand, if the destination identifier is the address of the PIF at which the message was originally received, then in step 216 the message is sent to the designated distributor through fabric 20 with the address of the PIF at which the message was originally received as the destination identifier. To illustrate, the destination identifier may be a three-bit number. For example, a destination identifier of 000 may correspond to PIF 40, and a destination identifier of 111 may correspond to PIF 47. In this case, the message will be sent to CIF 48 through fabric 20 when the destination identifier of 000 (associated with PIF 40) matches the PIF from which the message is being sent (in this case PIF 40). Such a method allows the reduction of logic that might otherwise be required to implement switching between levels of powers of two. In this example, fabric 20 may use 8-to-1 multiplexing to support nine PIFs 40-48. In general, fabric 20 may use n-to-i multiplexing to support n+1 PIFs using this method.

The method proceeds to step 218, where the message is stored into memory 58 at CIF 48. A descriptor may then be built for the message in step 220 using the associated data. Such a descriptor may include an index into memory 58. In a particular embodiment, it may also be desirable to send the descriptor to a multicast/broadcast queue in step 222. For example, in burst situations, such a queue may allow CIF 48 to schedule broadcast and/or multicast of messages in addition to other multitasking functions.

In step 224, the message may be retrieved from memory 58 using the descriptor, and in step 226, the message is broadcast to designated locations using the associated data. For example, CIF 48 may send the message to all PIFs 41-47, or a designated subset thereof (in some applications, this has been referred to as multicast). In addition, CIF 48 may send the message to the designated plurality of PIFs using a variety of methods. For example, in a particular embodiment, CIF 48 may send the message to a single designated PIF and continue resending the same message to the next designated PIF until the message has been sent to all of the designated PIFs. This step may be performed using a variety of methods, which may depend on the structures of CIF 48 and the associated data.

FIG. 3 illustrates an example of forwarding data that may be used according to the teachings of the present invention. In this example, forwarding data 300 includes a destination identifier 301 and associated data 310. As discussed previously, destination identifier 301 may include three bits 302, 303, and 304 to represent PIFs 40-47 as the port identifier when a message is to be sent to CIF 48.

Associated data 310 may be a bitmap that indicates to which designated locations the message is to be broadcast. For example, as illustrated, associated data 310 includes eight bits 311-318, which may be turned “on” or “off”. In this example, associated data 310 may be used as a mask, where those bits that are turned “on”, or have a value of 1, may efficiently provide the designated locations to which the message is to be broadcast. Each bit 311-318 corresponds to one of PIFs 40-47 as a designated location, and may be mapped using any desired scheme. For example, bits 311 and 312 may be mapped respectively to PIFs 40 and 41, or to PIFs 46 and 47, and the received message may be broadcast to those respective designated PIFs. Where the message is to be broadcast to all PIFs, each bit 311-318 may be turned “on”.

Associated data 310 may use other bitmapping as desired. For example, it may be desirable to designate locations to which to send the message by turning “off” the respective bit. Alternatively, associated data 310 may be an index such as a pointer to a bitmap or to another table, where desired. This provides a way to minimize the amount of associated data carried along with the message while allowing unlimited growth in switch size by mapping associated data with multicast broadcast maps in CIF memory.

In addition, although FIG. 1 illustrates a plurality of separate PIFs 40-48, memory element 50-58, and a fabric 20, some or all of these elements may be included in a variety of logical and/or functional configurations. For example, fabric 20 and one or more PIFs 40-48 may be designed using a single FPGA, and/or access a single memory element. Alternatively or in addition, each of the elements may be structured using a variety of logical and/or functional configurations, including buffers, modules, and queues.

While the invention has been particularly shown and described in several embodiments by the foregoing detailed description, a myriad of changes, variations, alterations, transformations and modifications may be suggested to one skilled in the art and it is intended that the present invention encompass such changes, variations, alterations, transformations and modifications as fall within the spirit and scope of the appended claims.

What is claimed is:

1. An efficient multiplexing method, comprising:
receiving a message at a first of a plurality of ports, the message associated with a destination;
if the destination is the first of the plurality of ports, sending the message to the destination;
else if the destination is a designated distributor, associating with the message a destination identifier of the first of the plurality of ports and sending the message to the designated distributor through a switching fabric; and
else if the destination is not the designated distributor, sending the message to the destination through the switching fabric.

2. The method of claim 1, wherein the plurality of ports is the sum of one and n and the switching fabric utilizes n-to-one multiplexing logic, wherein n is a multiple of two.

3. The method of claim 1, wherein the switching fabric comprises a non-blocking crossbar architecture.

4. The method of claim 1, further comprising if the destination is the designated distributor, retrieving forwarding data associated with the message, the forwarding data associated with the destination, sending the message and at least a portion of the forwarding data to the designated distributor through the switching fabric, and sending the message from the designated distributor through the fabric to a plurality of destinations in the network using the forwarding data.

5. The method of claim 4, wherein the associated data comprises a bit mask.

6. The method of claim 4, wherein sending the message comprises one of the group consisting of broadcasting the message to all of the plurality of nodes and broadcasting the message to a designated portion of the plurality of nodes.

7. An efficient multiplexing system, comprising:
a switching fabric operable to send a message to a designated distributor if a destination identifier matches a receiving port of a plurality of ports;
a designated distributor coupled to the switching fabric; and
a plurality of ports coupled to the switching fabric, each of the plurality of ports operable to:
receive the message at the receiving port of the plurality of ports, the message associated with a destination;
if the destination is the receiving port of the plurality of ports, send the message to the destination;
else if the destination is the designated distributor, associate with the message the destination identifier of the receiving port of the plurality of ports and send the message to the designated distributor through the switching fabric; and
else if the destination is not the designated distributor, send the message to the destination through the switching fabric.

8. The system of claim 7, wherein the plurality of ports is the sum of one and n and the switching fabric utilizes n-to-one multiplexing logic, wherein n is a multiple of two.

9. The system of claim 7, wherein the switching fabric comprises a non-blocking crossbar architecture.

10. The system of claim 7, wherein the plurality of ports are each further operable to, if the destination is the designated distributor, retrieve forwarding data associated with the message, the forwarding data associated with the destination and to send the message and at least a portion of the forwarding data to the designated distributor through the switching fabric, and the designated distributor is further operable to send the message through the fabric to a plurality of destinations in the network using the forwarding data.

11. The system of claim 10, wherein the associated data comprises a bit mask.

12. The system of claim 10, wherein the designated distributor is operable to send the message by a broadcast of the message to all of the plurality of nodes or a broadcast of the message to a designated portion of the plurality of nodes.

13. Data multiplexing logic, comprising:
a switching fabric operable to send a message to a designated distributor logic node if a destination identifier matches a receiving node of a plurality of output nodes;
logic coupled to the switching fabric, the logic comprising the plurality of output nodes and the designated distributor node, the logic operable to:
receive the message at the receiving node of the plurality of output nodes, the message associated with a destination;
if the destination is the receiving node of the plurality of output nodes, send the message to the destination;
else if the destination for the message is the designated distributor logic node, associate with the message the destination identifier of the receiving node of the plurality of output nodes and send the message to the designated distributor logic node through the switching fabric; and
else if the destination for the message is not the designated distributor logic node, send the message to another of the plurality of output nodes through the switching fabric.

14. The logic of claim 13, wherein the plurality of ports is the sum of one and n and the switching fabric utilizes n-to-one multiplexing logic, wherein n is a multiple of two.

15. The logic of claim 13, wherein the switching fabric comprises a non-blocking crossbar architecture.

16. The logic of claim 13, wherein the logic comprising the plurality of output nodes is further operable to, if the destination is the designated distributor logic node, retrieve from a memory forwarding data associated with the received message, the forwarding data associated with the destination, send the message and at least a portion of the forwarding data to the designated distributor through the switching fabric, and the designated distributor logic node is further operable to send the message through the switching fabric to at least a portion of the plurality of output nodes using the forwarding data.

17. The logic of claim 16, wherein the designated distributor logic node, the switching fabric, and the plurality of output nodes utilize at least one field programmable gate array.

18. The logic of claim 16, wherein the associated data comprises a bit mask.

19. The logic of claim 16, wherein the designated distributor is operable to send the message by broadcasting of the message to all of the plurality of nodes or broadcasting the message to a designated portion of the plurality of nodes.

20. The logic of claim 16, wherein the memory comprises a content-addressable memory.
